(19) United States
(12) Patent Application Publication
(10) Pub. No.: US 2009/0151129 A1
(43) Pub. Date: Jun. 18, 2009

(54) High Capacity Paper Clip

(76) Inventor: Stephen M. Crosson, Bayonne, NJ (US)

Correspondence Address: DONALD W. MEEKER, 924 EAST OCEAN FRONT, # E, NEWPORT BEACH, CA, 92661, US

(21) Appl. No.: 11/955,384

(22) Filed: Dec. 12, 2007

(51) Int. Cl. B42F 1/02

(52) U.S. Cl. 24/67.9

(57) ABSTRACT

A high capacity paper clip which is able to accommodate thin or thick insertions of paper. The paper clip is formed by bending a continuous elongated oval loop of wire over onto itself with a first bent portion of the loop longer than a second bent portion, leaving a tensioning expansion loop at the bend in each arm of the shorter bent portion to allow the paper clip to expand wide for the insertion of bulky stacks of paper.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to paper clips and particularly to a high capacity paper clip which is able to accommodate thin or thick insertions, the paper clip is formed by bending an elongated oval loop of wire over onto itself with a first bent portion of the loop longer than a second bent portion, leaving an extra loop at the bend to allow the paper clip to expand wide for insertion of bulky stacks of paper.

2. Description of Related Art Including Information Disclosed Under 37 CFR 1.97 and 1.98

It is well known to employ staples as well as paper clips to hold sheets of paper together such as the standard metal oblong-shaped paper clip or the metallic clamping paper clip having two pressure bearing legs that must be separated to insert paper there between.

The ordinary prior art paper clip is a series of curls one inside another, and uses a “pinch-hold,” mechanism to work. It is on one plane.

There is a need for a paper clip that is unlike the favorite prior art, which can only handle a modest few number of documents without encountering warping and other problems due to stresses placed on the prior art. The prior art standard paper clip twists when filled beyond capacity and causes damage to the paper. Several high capacity wire paper clips have been devised to counter such a problem, many of which have crossing arm or leg elements, such as those found in U.S. Pat. Nos. 1,783,099; 1,753,094; 4,597,139; 4,949,435; and 5,406,680.

Prior art U.S. Pat. No. 1,793,520, issued Feb. 24, 1931 to Siptrott, is for a binder for loose sheets and the like which is formed from wire. The binder has a loop with a bifurcated stem having legs that are close and parallel to each other.

Prior art U.S. Pat. No. 4,901,962, issued Feb. 20, 1990 to Greer, provides a clip for holding papers to a wall which is composed of a resilient material such as steel wire or a plastic that is formed for attachment to the fabric surface of a modular wall unit, and which will hold papers thereto.

Prior art U.S. Pat. No. 5,655,266, issued Aug. 12, 1997 to Gish, shows a paper clip formed of a single resilient wire that can torsionally grasp a thick sheaf of papers without deforming and can be used either along the straight sides of the paper or at a corner.

Prior art U.S. Pat. No. 5,022,124, issued Jun. 11, 1991 to Yiin, claims a novel clip device which comprises a first clipping member with a shape of loop and is made from elastic rod material; a bending member, connected upwardly to one end of the first clipping member; a second clipping member, having the similar shape as the first clipping member, connected to the upper end of the bending member. The second clipping member includes an inner loop member and an outer loop member. The bending member of the clip device provides a larger tolerance for the clip device to swallow the papers.

Prior art U.S. Pat. No. 1,495,297, issued May 27, 1924 to Gerla, describes a necktie clasp made from a single length of wire having an embodiment wherein a portion of a loop is bent over to form a clip.

Prior art U.S. Pat. No. 330,833, issued Nov. 17, 1885 to Harger, Jr., indicates a bed clothing clamp or fastener formed from a continuous loop of steel wire which is bent over to form a resilient clamping device.

Prior art U.S. Pat. No. 4,170,052, issued Oct. 9, 1979 to Okerblom, puts forth a wireform holding clip of low profile with substantially greater holding capacity and broad adjustment range so as to minimize “stack buildup” due to over extension, to accommodate substantial stack thickness, and to minimize the number of holding clip sizes required to serve a broad range of stack thicknesses.

Prior art U.S. Pat. No. 4,237,587, issued Dec. 9, 1980 to Hsiao, concerns a paper clip formed as an essentially unitary loop which is made of resilient material and comprises an isosceles triangle base portion, a first clipping portion and a second clipping portion. The first clipping portion and the second clipping portion can clip positively the documents in different directions respectively.

Prior art U.S. Pat. No. D28,534, issued May 3, 1898 to Thomson, illustrates the ornamental design for a fastening eye which comprises a continuous wire loop that is bent in half.

Prior art U.S. Pat. No. 2,843,900, issued Jul. 22, 1958 to Nye, is for a paper clip made from a single length of wire which is formed into a pair of opposed spring clasp structures, a ring-link clasp structure having legs which are bent to form the opposing second clasp structure.

Prior art U.S. Pat. No. 527,500, issued Oct. 16, 1894 to McCoole, provides a wire clothes pin which has a pair of opposed spring clasp structures, a first elongated clasp portion having legs which are bent to form the opposing second clasp structure.

What is needed is a high capacity paper clip made from a single piece of continuous wire in an oval shape with no single wire ends where the two arms of one of the U-shaped bars is bowed outwardly from the two arms of the other side leaving an expansion space adjacent to the bend to enable the paper clip to expand easily to hold a large number of papers between the two sides with the tension is absorbed in the bowed portions, as the two sides act as jaws to hold a thick stack of paper therebetween.

### BRIEF SUMMARY OF THE INVENTION

An object of the present invention is to provide a high capacity paper clip made from a single piece of continuous wire in an oval shape with no single wire ends, the paper clip bent from an elongated oval into two overlapping U-shaped bars, one longer than the other, that sit one on top of the other with the ends and most of the length of each side contacting the other side except at the bending point, where the two arms of one of the U-shaped bars is bowed outwardly from the two arms of the other side leaving an expansion space adjacent to the bend to enable the paper clip to expand easily to hold a large number of papers between the two sides with the tension is absorbed in the bowed portions, as the two sides act as jaws to hold a thick stack of paper therebetween thereby providing an inherently strong paper clip with a sure even grip with the two parallel U-shaped sides maintaining their shape since there are no single end pieces of wire to bend the paper clip out of shape and the tension bow enables even expansion of the two sides to maintain a parallel strong grip on the stack of paper regardless of the thickness of the stack within the range of each different size of paper clip.

Another object of the present invention is to provide a high capacity paper clip made from a single piece of continuous wire in an oval shape having no single wire ends, thereby preventing tears or damage to the paper.

One more object of the present invention is to provide a reusable high capacity paper clip which will not “deform” and is made from a single piece of continuous wire in an oval shape that is bent leaving a tensioning expansion loop adjacent to the bend which allows the paper clip to return to its original form without distortion after each use.

In brief, the present invention comprises a paper clip made from a single piece of wire bent from an elongated oval into two U-shaped bars that sit one on top of the other and which appear like the shape of a U. Such U-shaped bars, one lying on top of the other are connected in the back by two expansion loops which run from the front bars at the top, behind to the lower such U-shaped bar behind so that tension is absorbed in these loops, as the paper passes through the two bars much like jaws, in the two joined bars.

The present invention is three dimensional and uses two bars and these expansion loops to give a different kind of gripping to the paper, instead of relying on a “pinch-hold” of the classic paper clip. The present invention uses two bars with loops or prongs to strengthen the device which will act as a stronger holder of papers, and has a new hardy shape also for more durability, than the original prior art clip. The loops will absorb the pressure and stresses put under the clip, utilized by gripping, when the jaws are opened and paper inserted. The present clip invention is adapted to not “deform” and be used again and again if necessary.

The purpose of the device is to firmly hold large stacks of paper while still having enough tension to hold as little as two sheets of paper together. Another purpose of the present invention is to provide a reusable high capacity paper clip which will not become deformed and which springs back to its closed original form without distortion after use on a large stack of paper. A further purpose of the present invention is to provide a paper clip formed from a smooth continuous wire oval loop with which will not tear or damage the paper since there are no single wire ends.

An advantage of the present invention is that it accommodates large stacks of paper.

Another advantage of the present invention is that it has strong gripping tension to hold varying thicknesses of paper.

One more advantage of the present invention is that the paper clip will not twist or deform.

An additional advantage of the present invention is that it is reusable and springs back to its original form without distortion after each use.

A further advantage of the present invention is simple and inexpensive to manufacture.

Yet another advantage of the present invention is that it will not cause a stack of paper to warp or bulge.

A contributory advantage of the present invention is that it will not tear or damage the paper.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a view of the continuous wire oval loop of the present invention prior to being bent into the high capacity paper clip;

FIG. 2 is a view of the present invention wherein the continuous wire oval loop has been bent to form the high capacity paper clip;

FIG. 3 is a view of the present invention wherein the high capacity paper clip is holding a stack of paper.

### DETAILED DESCRIPTION OF THE INVENTION

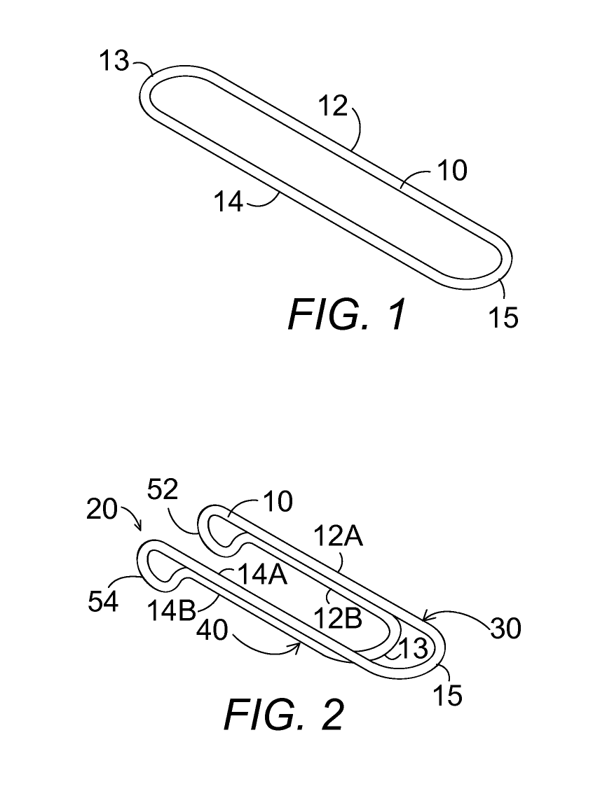

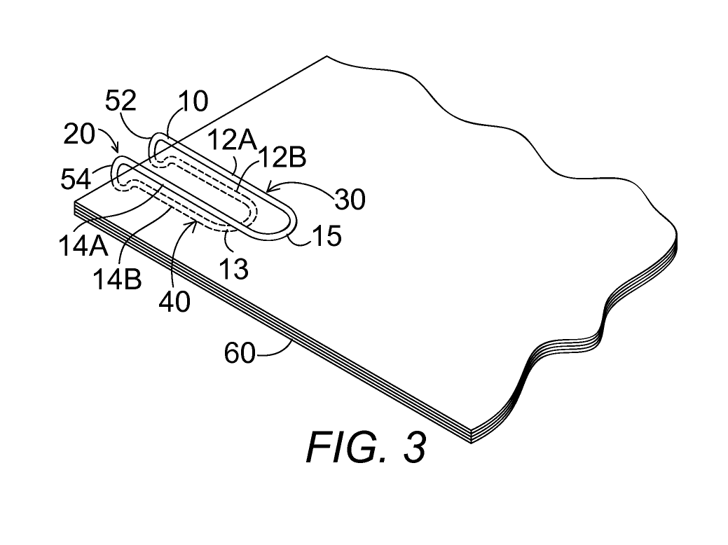

In FIGS. 1-3, a high capacity paper clip device 20 made from a single closed loop of wire 10 bent into a shape allowing the retention of a wide range of thicknesses of stacks of paper 60 retained therebetween. The device is a high capacity paper clip 20 comprising a single oval loop of continuous wire 10 with no single wire ends, as shown in FIG. 1. The single oval loop of continuous wire 10 is bent off-center, as shown in FIG. 2, forming two overlapping parallel U-shaped jaws 30 and 40 each comprising two parallel wire arms (12A and 14A, and 12B and 14B respectively) and an interconnecting curved outer end 15 and 13 between the two wire arms, with one of the U-shaped jaws 30 being longer than the other 40. The two overlapping U-shaped jaws 30 and 40 contact each other along most of the length of each of the arms (12A and 14A, and 12B and 14B respectively) with an outer end 15 of one of the U-shaped jaws 30 extending beyond the outer end 13 of the other of the U-shaped jaws 40. The device 20 further comprises a portion of one of the U-shaped jaws 40 having a loop 52 and 54 in each of the wire arms 14B and 12B curved outwardly away from the other of the U-shaped jaws 30 adjacent to the off-center bend to form an expansion portion 52 and 54 enabling the two U-shaped jaws 30 and 40 to expand over a wide range of separation of the two U-shaped jaws 30 and 40 to maintain a wide range of thicknesses of stacks of paper 60 between the two U-shaped jaws 30 and 40 while maintaining a substantially parallel relationship between the outer ends 15 and 13 of the two U-shaped jaws 30 and 40, as shown in FIG. 3.

The present invention 20 is made out of one piece of resilient steel wire which is formed into a continuous oval loop 10, as shown in FIG. 1. The continuous wire oval loop 10 is bent into two U-shaped jaws 30 and 40 with wide loops 52 and 54 at the bending point to support a large stack of paper 60. The present invention 20 works in a manner that the paper 60 slides between the two jaws 30 and 40 which are strengthened and reinforced by the two identical expansion loops 52 and 54 in one of the jaws 40 adjacent to the bend between the jaws 30 and 40. The high capacity paper clip 20 holds many sheets of paper 60 at one time and can be used over again, without losing its shape or form, as in the more conventional paper clip. The present invention 20 will hold paper 60 more firmly than the classic, regular paper clip, with no papers 60 sliding or falling out, and is usable for most office files and paper uses. The high capacity paper clip 20 will not cause a stack of paper 60 to become twisted or warped at the corner, or some of the problems commonly associated with the common desk paper clip.

The present invention 20 can hold most office files, even large stacks of paper 60 without having its strength compromised. The two reinforced double metal wire jaws 30 and 40 will return back into shape without any distortion after holding a large stack of paper 60. The expanding tension loops 52 and 54 give the high capacity paper clip 20 added strength and create enough tension between the U-shaped jaws 30 and 40 to hold as little as two sheets of paper together, or a large stack of paper 60, as shown in FIG. 3. The high capacity paper clip 20 maintains its form when holding a wide range of thicknesses of stacks of paper 60 between the two U-shaped jaws 30 and 40, keeping a substantially parallel relationship between the outer ends 15 and 13 of the two U-shaped jaws 30 and 40, as shown in FIG. 3. The present invention 20 will not cause warping or bulging of the papers 60 that it holds, or some of the problems commonly associated with the common desk paper clip. The present invention 20 is formed of a continuous wire oval loop 10 having no single wire ends which are commonly associated with prior art non-continuous wire paperclips, thereby preventing tears in the paper 60.

The present invention 20 can be cheaply manufactured and sold with little price difference than the original, classic paper clip. The high capacity paper clip 20 can be made in a wide variety of sizes, including standard paperclip sizes (28 mm and 50 mm).

The present invention 20 may be manufactured in a wide variety of thicknesses of wire 10 to vary the strength of the paper clip 20.

The present invention 20 may alternately be used to hold different items (not shown) of varying thicknesses together, other than paper.

It is understood that the preceding description is given merely by way of illustration and not in limitation of the invention and that various modifications may be made thereto without departing from the spirit of the invention as claimed.

What is claimed is:

1. A high capacity paper clip device made from a single closed loop of wire bent into a shape allowing the retention of a wide range of thicknesses of stacks of paper retained therebetween, the device comprising:
a high capacity paper clip comprising a single oval loop of continuous wire with no single wire ends, the single oval loop of continuous wire having an off-center bend forming two overlapping parallel U-shaped jaws each comprising two parallel wire arms and an interconnecting curved outer end between the two wire arms, one of the U-shaped jaws being longer than the other, the two overlapping U-shaped jaws contacting each other along most of the length of each of the arms with an outer end of one of the U-shaped jaws extending beyond the outer end of the other of the U-shaped jaws, and a portion of one of the U-shaped jaws further comprising a loop in each of the wire arms curved outwardly away from the other of the U-shaped jaws adjacent to the off-center bend to form an expansion portion enabling the two U-shaped jaws to expand over a wide range of separation of the two U-shaped jaws to maintain a wide range of thicknesses of stacks of paper between the two U-shaped jaws while maintaining a substantially parallel relationship between the outer ends of the two U-shaped jaws.
